(19) United States
(12) Patent Application Publication
(10) Pub. No.: US 2025/0170628 A1
(43) Pub. Date: May 29, 2025

(54) UPFLOW LEACH BED REACTOR FOR WASTE PROCESSING

(71) Applicants: COLORADO STATE UNIVERSITY RESEARCH FOUNDATION, Fort Collins, CO (US); ALLIANCE FOR SUSTAINABLE ENERGY, LLC, Golden, CO (US)

(72) Inventors: Lucas Hans LOETSCHER, Broomfield, CO (US); Sybil SHARVELLE, Fort Collins, CO (US); Kadin C YOUNG, Fort Collins, CO (US); Violeta SANCHEZ NOGUE, Golden, CO (US)

(21) Appl. No.: 18/726,996

(22) PCT Filed: Jan. 9, 2023
(86) PCT No.: PCT/US2023/060342

§ 371 Date: Jul. 5, 2024

Related U.S. Application Data
(60) Provisional application No. 63/297,620, filed on Jan. 7, 2022.

(51) Int. Cl. B09B 3/65; B09B 101/05

(52) U.S. Cl. CPC B09B 3/65; B09B 2101/05

(57) ABSTRACT

An upflow leach bed reactor configured to contain a substrate is provided. The reactor includes a container comprising a floor and a sidewall and configured to contain the substrate. The reactor further includes a fluid injection system including a plurality of fluid inlet ports arranged in an array across the floor. The fluid inlet ports can be moved between a first position below the substrate and a second position at least partially within the substrate. The reactor can also include a vertical drain extending from the top to the floor, between the substrate and the sidewall, and configured to permit downward liquid flow and inhibit upward liquid flow therethrough. The reactor can further include an inflatable bladder positioned adjacent the top of the container and configured to press downward against a top surface of the substrate.

### CROSS-REFERENCE TO RELATED APPLICATIONS

The present application claims priority to U.S. Provisional Patent Application No. 63/297,620, filed Jan. 7, 2022, the entire contents of which are hereby incorporated by reference.

### STATEMENT REGARDING FEDERALLY SPONSORED RESEARCH

N/A

### FIELD OF THE INVENTION

The disclosed technology is generally directed to solid waste processing methods. More particularly the technology is directed to use of an upflow leach bed reactor for solid waste processing.

### BACKGROUND OF THE INVENTION

Anaerobic digestion is a waste management technology that uses microorganisms to convert organic matter into biogas and a nutrient-rich fertilizer. It has numerous environmental, economic, and social benefits, such as reducing the amount of solid waste generated, providing an energy source, and creating jobs in the local community. For example, anaerobic digestion reduces the amount of solid waste generated in a community, as the organic matter is converted into biogas and fertilizer. Moreover, the biogas produced can be used as an energy source, and the fertilizer can be used to improve soil health. This helps to reduce reliance on fossil fuels and chemical fertilizers, which have a negative impact on the environment. Additionally, anaerobic digestion can reduce odors associated with organic waste, helping to improve local air quality. Furthermore, anaerobic digestion can be an economically viable waste management solution, as it can generate revenue for the community through the sale of biogas and fertilizer. In addition, the process does not require significant investment in infrastructure and can be relatively easy to maintain. Finally, anaerobic digestion can help to create jobs in the local community, as the technology requires qualified personnel to operate and maintain. Overall, anaerobic digestion is an effective and sustainable method of managing organic waste. However, treating solid waste with anaerobic digestion has several challenges, such as the lack of homogeneity in the waste stream, the slow process, and the disruption by environmental factors.

More specifically, one challenge of treating solid wastes with anaerobic digestion is the lack of homogeneity in the waste stream. Solid wastes are comprised of a variety of materials, from paper and cardboard to food scraps and yard waste. These materials need to be sorted, processed, and pre-treated before they can be properly digested. This requires the use of specialized equipment, as well as the ability to accurately measure and monitor the progress of the digestion process. Another challenge of treating solid wastes with anaerobic digestion is the fact that it is a relatively slow process. Anaerobic digestion is a biological process that relies on the action of microbes, and it can take several weeks or months to complete. This can be a problem when dealing with large volumes of waste that need to be processed quickly. Additionally, the process can be disrupted by changes in temperature, pH, and other environmental factors, leading to reduced efficiency and greater costs.

Accordingly, anaerobic digestion is an attractive technology for waste handling because it converts low-value waste material into energy and other useful products while performing necessary treatment for proper waste disposal. Conventional anaerobic digestion technology, however, has been met with many economic challenges when being applied to high solids feedstock such as dry-lot cattle manure. For example, in Colorado and the rest of the arid west, feedlot practices and dry climate combine to form a waste product that is very high in total solids content, from 50% up to 90%. Since the most common conventional digestion practices typically can only treat wastes up to a maximum of 15% total solids, other options must be considered to digest this abundant waste product and convert it to a valuable resource.

Feedlot livestock manure is a ubiquitous organic waste product in some arid regions, for example, the western states of the U.S., which poses a unique challenge for digestion, as the dry climate and local feedlot practices combine to produce a product that is often as high as 90% total solids content which is heavily contaminated with inorganic materials like rocks and sand. This “dry scrape” manure management practice severely limits the possibilities of digestion in a conventional anaerobic digester. Significant water addition would be necessary to achieve a lower solids content like that seen in a typical complete-mix digester. The high costs and scarcity of water in the arid west renders this an impractical solution. Considering the low availability of water in the area, conventional digester technologies are not a pragmatic solution to treat livestock manure waste in these regions.

### BRIEF SUMMARY OF THE INVENTION

Some embodiments provide an upflow leach bed reactor configured to contain a substrate. The reactor includes a container comprising a floor and a sidewall and configured to contain the substrate. The reactor further includes a fluid injection system positioned adjacent the floor and configured to inject liquid upward into the substrate. The fluid injection system includes a plurality of fluid inlet ports arranged in an array across the floor. The plurality of fluid inlet ports are configured to be moved between a first position below the substrate and a second position at least partially within the substrate.

Some embodiments provide an upflow leach bed reactor configured to contain a substrate. The reactor includes a container comprising a floor and a sidewall and configured to contain the substrate. The reactor further includes a base drain positioned adjacent the floor The reactor also includes a vertical drain extending from the top to the floor and positioned between the substrate and the sidewall. The vertical drain is configured to permit downward liquid flow and inhibit upward liquid flow therethrough.

Some embodiments provide an upflow leach bed reactor configured to contain a substrate. The reactor includes a container comprising a floor and a sidewall and configured to contain the substrate. The reactor further includes a fluid injection system positioned adjacent the floor and configured to inject liquid upward into the substrate. The reactor also includes an inflatable bladder positioned adjacent the top of the container and configured to press downward against a top surface of the substrate.

Some embodiments provide a method comprising loading a feedstock into an upflow leach bed reactor and conditioning the feedstock, where conditioning includes injecting one of ozone and ammonia into the feedstock. The method further includes performing biological processing on the feedstock and dewatering the feedstock.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 illustrates a schematic diagram of a multistage digestion system according to some embodiments.

FIG. 2 illustrates a schematic diagram showing the liquid flow and gas flow between components of the multistage digestion system of FIG. 1.

FIG. 3 illustrates a schematic diagram a modular multistage digestion system according to some embodiments.

FIG. 4 illustrates a schematic view of an upflow leachate bed reactor (ULBR), according to some embodiments.

FIG. 5A illustrates a cross-sectional view of a ULBR according to some embodiments.

FIG. 5B illustrates a partial cross-sectional view of a vertical drain, according to some embodiments, for use in the ULBR of FIG. 5A.

FIG. 6 illustrates a cross-sectional view of another ULBR according to some embodiments.

FIG. 7 illustrates a perspective, unassembled view of an example ULBR held in a tilted position by a frame, showing the interior before installation of collection systems and injection systems.

FIG. 8 illustrates a perspective, partially assembled view of a substrate base and fluid injection system inside the ULBR of FIG. 7.

FIG. 9 illustrates a perspective view of a lid and collection systems of the ULBR of FIG. 7.

FIG. 10 illustrates a chart showing exemplary ULBR process operating modes.

### DETAILED DESCRIPTION OF THE INVENTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices, and methods relating to surface patterning are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

Generally, some embodiments provide an upflow leach bed reactor (ULBR) that can provide an effective and efficient way to process a variety of wastes. The ULBR operates in a multimodal fashion to condition wastes, such as solid feedstocks, hydrate the wastes, and facilitate the bioprocessing of the wastes. It is highly resilient to the processing of heterogeneous feedstocks, low permeability feedstocks, and inorganic contaminates entrained in the feedstocks. The ULBR can also be used as part of a multistage reactor system, such as a multistage anaerobic digestor (MSAD), where leachate from multiple vessels may be pooled together to be processed by a central high-rate methanogenic reactor.

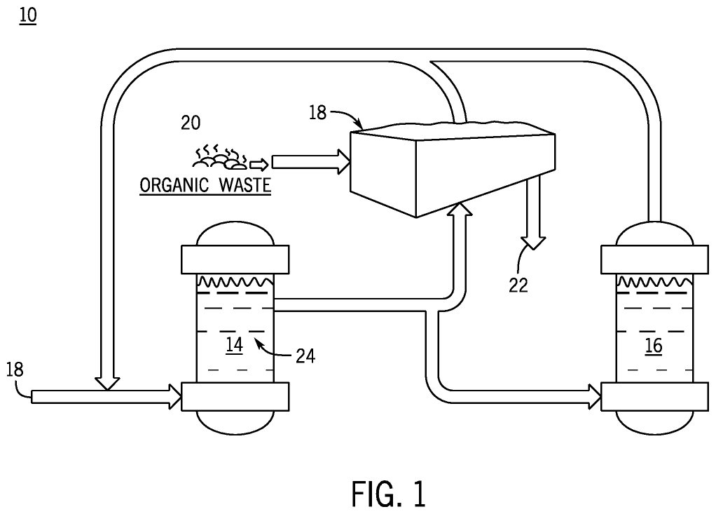

For example, FIG. 1 illustrates a MSAD 10, according to some embodiments, including a ULBR 12, a leachate feed tank (LFT) 14, and a fixed film reactor (FFR) 16. The ULBR 12, the LFT 14, and the FFR 16 can be fluidly connected to permit the passage of liquids and gasses between the components. Generally, dilution water 18 and a substrate 20 (e.g., organic waste) are introduced to the MSAD 10, and through the addition of water and cultivation of bacteria with the substrate 20, the MSAD 10 generates products 22, such as compost or fertilizer and biogas. According to some embodiments, the substrate 20 can be a solid or a liquid, or a mixture thereof and can comprise any biomass such as, but not limited to, feedstock, manure, seaweed, food waste, kelp, algae, municipal solid wastes, crop residues, and food processing wastes.

More specifically, the substrate 20 (e.g., high solids cattle manure, in one application) may be provided into the ULBR 12, along with water 18, and allowed to digest for a time period. The LFT 14 is fluidically connected to the ULBR 12 to recirculate a leachate 24 through the ULBR 12 during the digestion process. The FFR 16 (e.g., a high rate methanogenic reactor) is fluidically connected to the LFT 14 to cycle the leachate 24 in a fixed film environment for biogas production. It is noted, however, that biogas may be generated in any or all of the reactors 12, 14, 16, and biogas may be generated on a continuous basis, e.g., after digestion begins. Following the digestion process, the stabilized waste material may be removed from the ULBR 12 and composted.

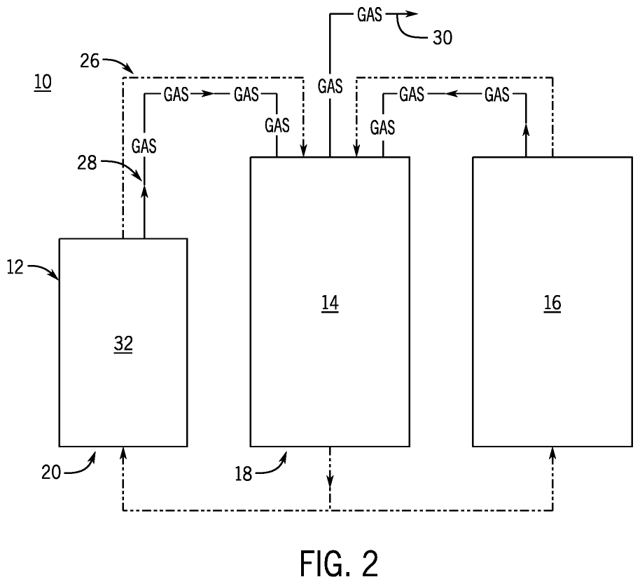

Accordingly, FIG. 2 shows one example of liquid flow paths 26 and gas flow paths 28 between the ULBR 12, the LFT 14, and the FFR 16 within the MSAD 10. As shown in FIG. 2, the substrate 20 can be loaded into the ULBR 12. The ULBR 12 can further be filled with water, and a leachate 24 from the LFT 14 can be circulated through the ULBR 12. That is, via the liquid flow path 26, the leachate 24 enters the ULBR 12 at the bottom and exits the ULBR 12 at the top, and organics can be leached out of the substrate 20 by passing the leachate 24 upwards through the substrate 20 within the ULBR 12. As a result, the leachate 24 contains organic materials and inorganic materials such as salts that have been leached from the substrate 20 as the liquid passes through the substrate 20. The leachate 24 from the ULBR 12 flows back into the LFT 14, where it may be refreshed with dilution water 18, and recirculates continuously through the ULBR 12, while the solid substrate 20 is retained in the ULBR 12.

Furthermore, leachate 24 is drawn out of the LFT 14 to feed the FFR 16, which houses methanogens on attached growth media. The organics previously leached from the ULBR 12 are readily degraded in the FFR 16 to produce biogas, and the digested leachate 24 is then discharged back into the LFT 14 where it can be fed back into the ULBR 12 again to replenish the biochemical methane potential (BMP, a measure of leached organic content available for digestion). This design allows for much shorter hydraulic retention times as active methanogens are retained on floating plastic media within the FFR 16.

Additionally, as shown in the gas flow path 28 of FIG. 2, gases, such as methane gases 30, can be collected from the ULBR 12, the LFT 14, and/or the FFR 16, and output from the LFT 14. For example, gas can accumulate in the headspace of the LFT 14 and can be directed to vent, to storage, or to an energy-generating processes. However, in other embodiments, gases may be output directly from the ULBR 12, the FFR 16, and/or the LFT 14. It should also be noted that, in some embodiments, liquid flow in the MSAD 10 can be directed by at least one pump (not shown). Additionally, further description of the FFR 16 as well as the LFT 14 and overall gas and liquid flow process of the MSAD 10 may be found in U.S. Pat. No. 8,894,854, the entire contents of which is incorporated herein by reference.

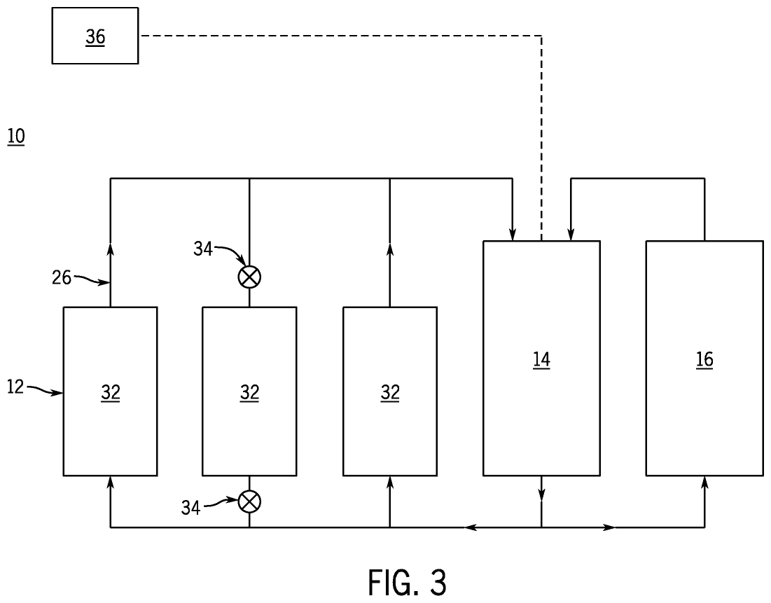

In some embodiments, the MSAD 10 can incorporate a modular system. For example, the ULBR 12 can include one reactor 32, as shown in FIG. 2, or a plurality of individual reactors 32, as shown in FIG. 3, in series or parallel. Accordingly, reference may be made herein to the ULBR 12 generally or to an individual reactor 32, and the terms may be used interchangeably unless otherwise noted. As shown in FIG. 3, the multiple reactors 32 can each be fluidly connected to the LFT 14. Valves 34 can be included along the liquid flow path 26 (and/or the gas flow path 28) between one or more of the reactors 32 and the LFT 14 such that the liquid flow 26 (and/or gas flow 28) between a particular reactor 32 and the LFT 14 can be inhibited by adjusting the corresponding valves 34. As such, the valves 34 allow the individual reactor 32 to be isolated from the LFT 14, for example, so that the reactor 32 can be removed from the MSAD process (e.g., to allow removal of stabilized waste and introduction of new organic waste) while remaining reactors 32 can continue operations. It should also be noted that, in some embodiments, the MSAD 10 can include more than one LFT 14 and/or more than one FFR 16. Additionally, while the system 10 of FIG. 3 illustrates the reactors 32 in parallel, in some embodiments, the system 10 can include a plurality of reactors 32 in series. For example, leachate that has been drained from reactor 32 can be directed into a subsequent reactor 32 prior to reaching the LFT 14.

In some embodiments, the MSAD 10 can be mobile. For example, the reactors 32, the LFT 14, and/or the FFR 16 can each be sized and configured to be able to fit on a truck and comply with interstate highway regulations. Furthermore, the MSAD 10 has low requirements for added water as leachate 24 is recycled through the system 10 during processing. Therefore, little additional water 18, if any, is needed onsite. Accordingly, the mobility of the MSAD 10 and its water requirements allows it to be moved to remote locations for waste processing, such as seasonal waste.

Furthermore, referring back to FIG. 3, in some embodiments, the MSAD 10 can include a controller 36, such as but not limited to a programmable logic controller (PLC) or microcontroller with stored instructions in memory and a processor, configured to monitor variables within the MSAD 10 and/or automate some or all operations of the MSAD 10. For example, in some applications, the controller 36 can be in communication with probes or other means for monitoring parameters such as, but not limited to, organic content, electrical conductivity, pH, temperature, liquid and gas flow, pressure, liquid level, and safety functions, such as gas concentration and pressure monitoring, within the MSAD 10. Using these inputs, the controller 36 can be programmed to maintain parameters within desired operational ranges. Additionally, in some embodiments, the controller 36 can output to a Human Machine Interface (HMI), such as a remote touchscreen monitor (not shown), to assist an operator in tracking system parameters and control functions. For example, the HMI can present graphs and histograms of system parameters over the most recent hour, 12-hour, and 24-hour time periods to help the operator monitor system performance. The controller 36 can also be programmed with run commands and timing for operating the MSAD 10. For example, liquid leachate 24 recirculation may be accomplished using the controller 36 in various circumstances, including, but not limited to, heating, adjusting pH, or any other time more flow is needed. In these circumstances, the controller 36 can operate, for example, a pump to move leachate 24, steam, or another fluid and/or a heater to heat a liquid being pumping into the reactor 32. For example, measurements such as pH and organic content of leachate in the ULBR 12 can be used by the controller 36 to increase or decrease pumping rates to the ULBR 12, thereby permitting optimization of electrical utilization of the module. As another example, measurements such as pH and organic content of leachate collected from leachate in the ULBR 12 can be used by the controller 36 to configure the composition of the leachate injected into the ULBR 12, based on the selection of the appropriate location the leachate was stored within the MSAD 10. As yet another example, measurements such as pH and organic content of leachate collected from leachate in the ULBR 12 can be used by the controller 36 to configure the location the leachate is directed to after it leaves the ULBR 12. As an additional example, measurements such as pH and organic content of leachate collected from the ULBR effluent can permit the controller 36 to increase or decrease the mixing rate through a plurality of mixing methods, including gaseous mixing, leachate mixing, and actuated mixing. Accordingly, any operation or actuation of components within the ULBR 12 or MSAD 10 discussed herein may be controlled by the controller 36 in some embodiments.

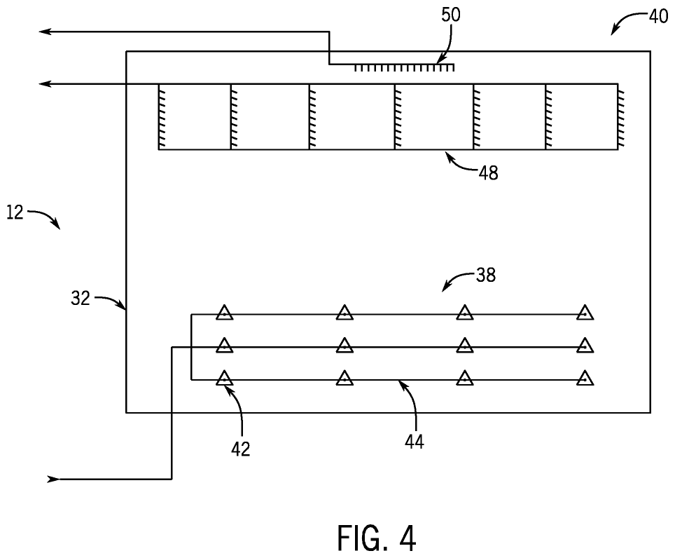

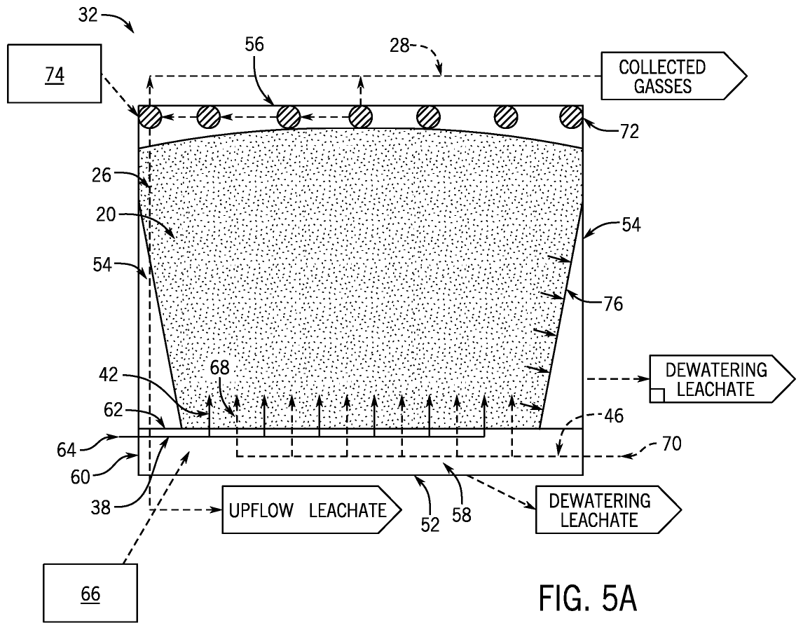

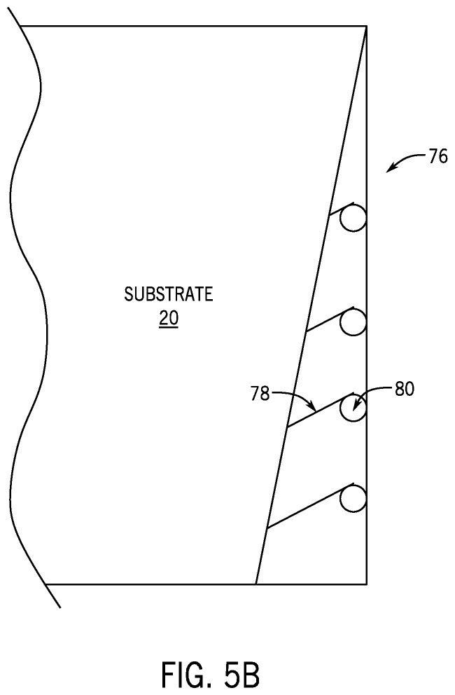

Turning now to FIG. 4, a schematic view of a reactor 32, according to some embodiments, is illustrated. As shown in FIG. 4, the reactor 32 can include at least a fluid injection system 38 and a collection system 40. The fluid injection system 38 can be located at the bottom of the reactor 32, enabling upflow liquid movement, as further discussed below. In some embodiments, the fluid injection system 38 can include a plurality of fluid inlet ports 42 fluidly connected by an array of conduits 44. Liquid or gas can be directed through the conduits 44 and introduced to the reactor 32 via the fluid inlet ports 42. Similarly, a dedicated gas injection system 46, such as that shown in FIG. 5A, can be provided at the bottom of the reactor 32 to introduce gas into the reactor 32.

Additionally, the collection system 40 can be located at the top or along the sides of the reactor 32. In some embodiments, the collection system 40 can include a leachate collector 48 and a gas collector 50. In some embodiments, the leachate collector 48 can include an array of connected tubes with openings such that liquid, e.g., leachate 24, can enter the tubes and be directed out of the reactor 32. Furthermore, in some embodiments, the gas collector 50 can include an array of connected tubes with openings such that gases from the reactor 32, such as air or biogas, can enter the tubes and be directed out of the reactor 32. In some embodiments, the leachate collector 48 and the gas collector 50 can be incorporated (individually or collectively) into one or more drains, as further described below.

FIG. 5A illustrates another detailed view of a reactor 32 according to some embodiments. As shown in FIG. 5A, the reactor 32 can include a bottom floor 52, side walls 54, and a top or roof structure 56, forming a container. The reactor 32 can further include a substrate base 58, a base drain 60, a fluid injection system 38, a gas injection system 46, and a collection system 40. In some embodiments, the reactor 32 can have a capacity based on a specific application and can range, for example, anywhere between about 50 gallons and about 1 million gallons, or more. Thus, by way of example, in some embodiments, the reactor 32 can have a capacity of about 200 gallons, 500 gallons, 1,000 gallons, 500,000 gallons, 1 million gallons, or 2 million gallons. It should also be noted that, due to the modularity of the system 10, as described above, multiple reactors 32 can be placed together in parallel to increase the capacity of the ULBR 14, and vice versa.

Generally, the substrate base 58 can support the solid substrate 20 and can be mounted inside the reactor 32 along the bottom floor 52. The substrate base 58 can be, for example, a pallet, comprised of plastic or another suitable material. The substrate base 58 can include a top portion 62 that is spaced from the bottom floor 52 and that supports the substrate 20. The substrate base 58 can provide sufficient space adjacent the bottom floor 52 to permit routing of the fluid injection system 38 and the gas injection system 46, as further described below. Additionally, a base drain 60 can be provided at the bottom of the reactor 32, for example, to drain the leachate 24 at the end of a processing cycle during a dewatering operation. In some embodiments, the base drain 60 can be integrated into the floor 52 of the reactor 32 and can be accessed through a hole (not shown) in the substrate base 58. Alternative, in some embodiments, the base drain 60 can be integrated into one of the side walls 54 adjacent to the floor 52. Additionally, in some embodiments, the base drain 60 can include a filter (not shown). In one example, the filter can be a coarse synthetic geotextile fabric or mesh made from metals such as, but not limited to, stainless steel.

Referring still to FIG. 5A, the fluid injection system 38 can include a set of inlet ports 42 that are evenly spaced, such as in an array or a grid arrangement. For example, in some embodiments, the fluid injection system 132 can include a low-pressure diffuser grid with the fluid inlet ports 42 extending upward therefrom. The fluid injection system 38 can be arranged at the bottom of the reactor 32, along or through the substrate base 58, and can generally span across a specified area, such as across the entire bottom of the reactor 32. Accordingly, the fluid inlet ports 42 can be positioned to inject liquid upwards directly into the substrate 20, generating “upflow” liquid movement. The liquid can be, for example, water, leachate, flocculants or coagulants, biological inoculants (either aerobic or anaerobic), or cleaning agents and can be introduced into the fluid injection system 38 via an inlet 64. Additionally, in some embodiments, the liquid can be heated by an external heater (not shown) before being introduced into the fluid injection system 38.

Generally, the upflow design of some embodiments can enable liquid flow to be sustained through the substrate 20 to generate a high organic content leachate 24. More specifically, the upflow configuration maximizes liquid distribution through the waste material to increase digestion of the material and organic content in the leachate 24. Furthermore, the design overcomes issues faced with existing systems to sustain liquid flow through challenging organic feedstocks (e.g., manure or other high solids waste), whereas the downward flow configuration often results in clogging.

Furthermore, in some embodiments, the fluid injection system 38 can include retractable ports 42 that can be actuated to extend into the substrate 20 during operation. For example, in some embodiments, the fluid inlet ports 42 can be positioned at a first vertical location below or even with the substrate 20, and moved into a second vertical location, into the substrate 20, in order to directly inject liquid into the substrate 20. By directly injecting liquid into the substrate 20, the fluid injection system 38 can further improve hydraulic distribution throughout the reactor 32 using minimal additional energy.

In some embodiments, the entire array 44 can be retractable, such that the entire array 44 is moved vertically up and down. In other embodiments, the fluid inlet ports 42 may be individually retractable, while the array 44 remains in a single, set position. Such retraction can be accomplished, for example, using a lift mechanism 66 to lift and lower the array 44 and/or ports 42. The lift mechanism 66 may be a motorized system that automatically moves the array 44 and/or ports 42 or a manual system that requires an operator to actuate such movement (e.g., such as rotating a lever connected to the array via a set of gears).

Additionally, in some embodiments, the fluid injection system 38 can be activated in a zonal manner. In other words, the set of fluid inlet ports 42 can be organized into zones or groups of fluid inlet ports 42. Some of the fluid inlet ports 42 (e.g., corresponding to one or more zones or groups) can be activated to inject liquid or gas into the substrate 20 while other fluid inlet ports 42 (e.g., corresponding to one or more other zones or groups) can remain inactive. Incorporating multiple zones of injection ports 68 can permit fluid flow to various portions of the reactor 32, thus facilitating fluid transfer and mixing within the reactor 32. According to one example, all of the fluid inlet ports 42 along one side of the reactor 32 can be activated to agitate one side of the substrate 20 such that the substrate 20 is turned over within the reactor 32.

In some embodiments, such activation and deactivation can be accomplished through sets of valves (not shown) within the array 44 in order to permit or inhibit liquid flow to certain zones. In other embodiments, such activation and deactivation can be accomplished through individually actuated inlet ports 42, configured to be opened or closed. Additionally, in some embodiments, the valves or inlet ports 42 can be actuated manually or automatically (e.g., via the controller 36).

Accordingly, the fluid injection system 38, including its bottom location for upflow movement, retraction capabilities, and/or zonal operation, can improve the liquid distribution within the substrate 20 and mixing of the liquid with the substrate 20 during processing. Additionally, and alternatively, the fluid inlet ports 42 can be configured to inject gaseous elements.

Still referring to FIG. 5A, the gas injection system 46 can include a set of injection ports 68 that are evenly spaced, such as in an array or a grid arrangement. For example, in some embodiments, the gas injection system 46 can include a high-pressure diffuser grid with the gas injector ports 68 extending upward therefrom to introduce gaseous elements to the reactor 32 such as, but not limited to, steam, biogas, air, ammonia, or ozone. The gas can be introduced into the gas injection system via an inlet 70. The gas injection system 46 can be arranged at the bottom of the reactor 32, along or through the substrate base 58, and can generally span across a specified area, such as across the entire bottom of the reactor 32. Accordingly, the gas injection ports 68 can be positioned to inject liquid upwards directly into the substrate 20, generating upflow gas movement.

In some embodiments, the gas injection ports 68 can be configured to be retractable such that the gas injection ports 68 can be actuated to extend into the reactor 32, into the substrate 20, or be withdrawn, similar to that described above with respect to the fluid injection system 38. Additionally, in some embodiments, the gas injection system 46 can be activated in a zonal manner, similar to that described above with respect to the fluid injection system 38. In other words, the gas injection ports 42 can be organized into zones or groups. Some of the gas injection ports 42 (e.g., corresponding to one or more zones or groups) can be activated to inject gas into the substrate 20 while other gas injection ports (e.g., corresponding to one or more other zones or groups) can remain inactive. Incorporating multiple zones of injection ports 68 can permit fluid flow to various portions of the reactor 32, thus facilitating fluid transfer and mixing within the reactor 32. Furthermore, as shown in FIG. 5A, the set of gas injection ports 68 can be separate from the fluid inlet ports 42. However, in some embodiments, the fluid injection system 38 can provide gas and, thus, can also serve as the gas injector system 46.

Still referring to FIG. 5A, the collection system 40 can be incorporated into a surface drain 72 positioned on or adjacent to the roof of the reactor 32. More specifically, the surface drain 72 can be positioned over the substrate 20 to permit the flow of liquids and gasses out of the reactor 32. For example, the surface drain 72 can receive liquids, such as upwardly flowing leachate 24, so that the liquids can be conducted to the LFT 14. The surface drain 72 can further receive gases from the reactor 32, such as gases emanating from the substrate 20 or gases that have been added during operation, and conduct the gases to the LFT 14.

In some embodiments, the surface drain 72 can be attached to the roof 56, which may be permanent or removable from the reactor 32. Additionally, in some embodiments, the reactor 32 can include a surface drain actuator 74 that can adjust a vertical position the surface drain 72. For example, the surface drain actuator 74 can be a mechanical actuator that urges the surface drain 72 downward onto a top surface of the substrate 20. In some embodiments, the mechanical actuator can include control rods and/or springs to accomplish vertical movement of the surface drain 72.

Furthermore, with reference to FIGS. 5A and 5B, the reactor 32 can include one or more vertical drains 76 located adjacent the side walls 54 and surrounding the substrate 20. In some embodiments, the vertical drains 76 can include a mesh, such as a fine stainless steel mesh or inorganic mesh fabric. In some embodiments, the vertical drains 76 can be aligned in a substantially straight vertical orientation between the bottom of the reactor 32 and the top of the reactor 32; however, in other embodiments, as shown in FIG. 5A, the vertical drains 76 can be angled outward from the bottom of the reactor 32 toward the top of the reactor 32. Additionally, in some embodiments, the vertical drains 76 can comprise a single, continuous vertical drain 76 that completely surrounds the substrate 20. In other embodiments, separate vertical drains 76 can be positioned around the substrate 20.

Generally, the vertical drains 76 can allow leachate 24 or other liquids to drain down toward the floor 52 of the reactor 32 and, more specifically, toward the bottom drain 60. For example, the vertical drains 76 can facilitate draining of liquids from the substrate 20, during dewatering operations, down toward the bottom drain 60. Furthermore, in some embodiments, the vertical drains 76 can be arranged to limit the upward passage of gases and liquids during operation, while still permitting the downward flow of liquid. More specifically, the vertical drains 76 can prevent liquid upflow from bypassing the substrate 20 during other digestion, i.e., urging liquid and gas flow from the liquid and gas injection systems to travel upward through the substrate 20 to the surface drain 72.

In some embodiments, to accomplish this functionality, the vertical drains 76 can include baffles 78 and/or check valves 80, as shown in FIG. 5B. The baffles 78 and check valves 80 can be arranged to permit liquid flow downward, e.g., for draining purposes, but generally inhibit liquid flow upward, e.g., that would allow liquid to bypass the substrate 20 to reach the collection system. That is, as shown in FIG. 5B, the baffles 78 can be angled upward away from the substrate to accomplish this functionality.

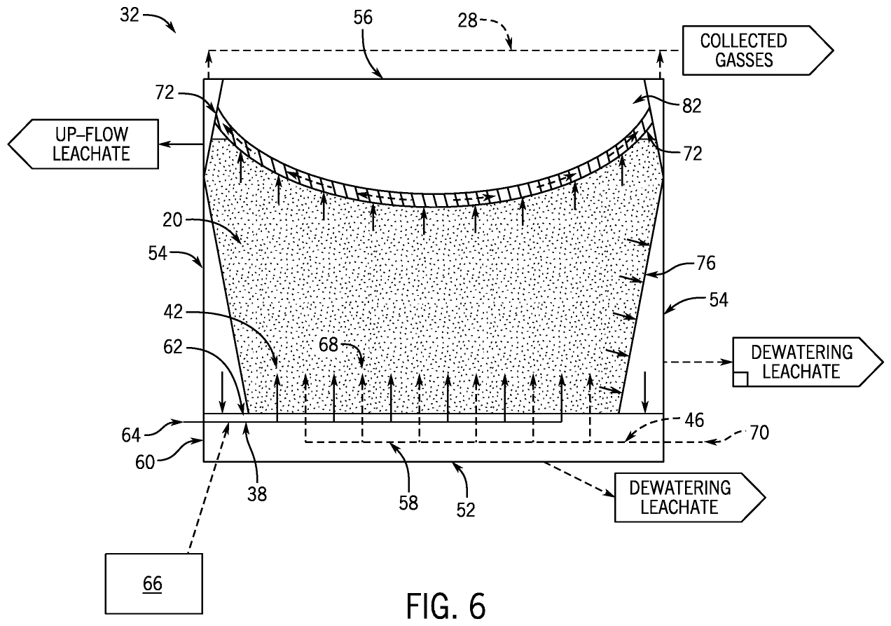

FIG. 6 illustrates another reactor 32 according to some embodiments. Generally, the reactor 32 of FIG. 6 can include all of the same components and functionality as that described above and shown in FIG. 5. However, the reactor 32 of FIG. 6 can further include a bladder 82, such as a flexible, expandable membrane, incorporating the surface drain 72. That is, as shown in FIG. 6, the surface drain 72 can be located along the bottom surface of the bladder 82 to collect liquid and gas from the top of the substrate 20.

The bladder 82 can take the place of the mechanical surface drain actuator 74 described above, to instead fluidly actuate movement of the surface drain 72 toward the substrate 20. For example, the bladder 82 can be selectively inflated to cause the surface drain 72 to contact the substrate 20 during operation. In some embodiments, gases from the reactor 32 (or the LFT 14 or the FFR 16) can be redirected to inflate the bladder 82 and, as a result, the bladder 82 may be used as a biogas storage system. Furthermore, in some embodiments, the bladder 82 can be used to measure volume reduction during operation, e.g., by monitoring a fill volume of the bladder 82 required for the surface drain 72 to reach the top of the substrate 20. Additionally, in some embodiments, the bladder 82 can be used to apply downward pressure onto the substrate 20, for example, during dewatering operations.

In some embodiments, the bladder 82 can comprise a plurality of bladders, for example, arranged side by side. The bladders 82 can be individually filled or drained at the same rate or at different rates. For example, filling the bladders 82 at different rates can cause extra pressure only along certain regions of the substrate 20, which can help agitate or mix the substrate 20.

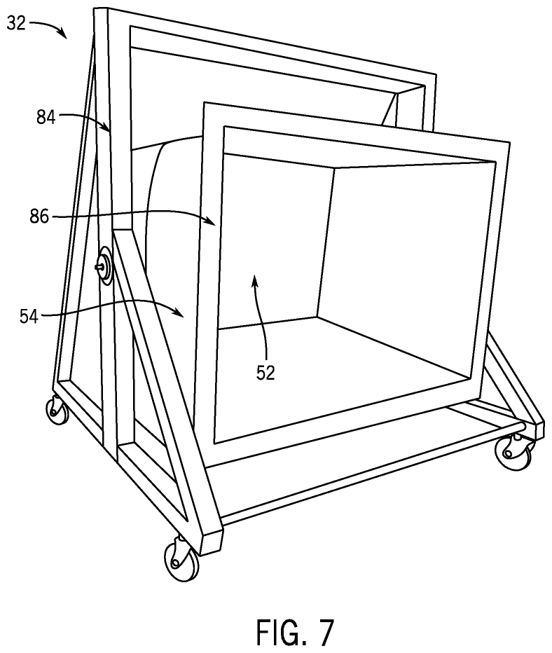

FIGS. 7-9 illustrate an example reactor 32 in various stages of assembly. According to the one embodiment, the reactor 32 illustrated in FIGS. 7-9 can be a construction dumpster having a capacity of about 800 gallons. FIG. 7 illustrates the reactor 32 in an unassembled state, without any components installed therein. The reactor 32 can be rotatably mounted on a frame 84 such that the reactor 32 can rotate between at least a first position and a second position. In some embodiments, the second position is at least 90 degrees from the first position, as rotated about a horizontal axis. For example, this rotation can facilitate substrate loading and/or removal from the reactor 32.

As shown in FIG. 7, the reactor 32 can have an opening 86 that allows access to the interior of the reactor 32. In some embodiments, the opening 86 is at the top of the reactor 32. More specifically, as shown in FIG. 7, the reactor 32 can include the bottom floor 52, the side walls 54, and an open top 86 (e.g., the reactor 32 is shown in FIG. 7 a position such that the open top 86 is rotated 90 degrees to be facing outward). Additionally and alternatively, the top 86 of the reactor 32 can be closed, i.e., by a roof 56, and one or more openings can be located along the side walls 54 of the reactor 32.

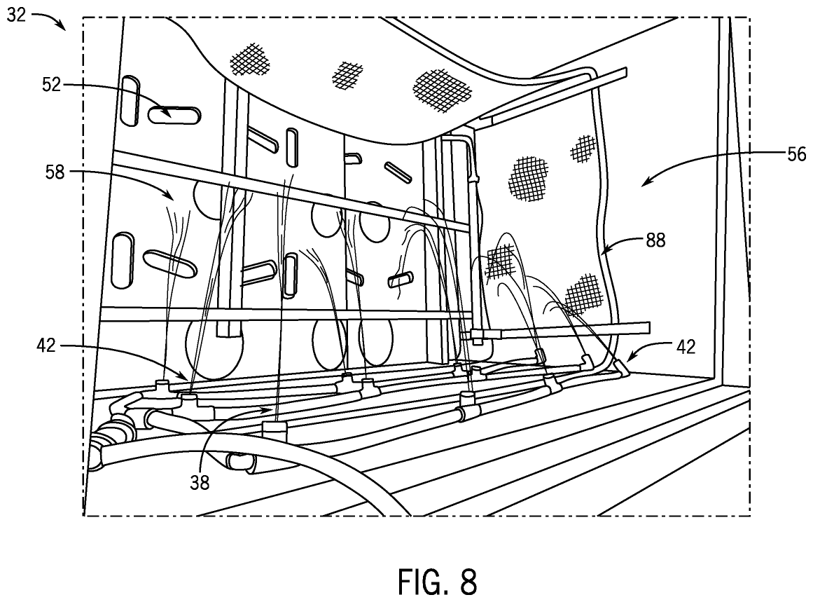

FIG. 8 illustrates the reactor 32 in a partially assembled state, including the fluid injection system 38 having spaced fluid inlet ports 42. In this exemplary view, the reactor 32 is on its side, and the fluid injection system 38 is not yet fully installed on the floor 52. That is, in a fully installed operational unit, the floor 52 of the reactor 32 would include the fluid injection system 38, e.g., installed in a raceway that runs the length of the reactor 32, where the track can include removable plates (not shown). For example, the plates may be removed to allow access to the fluid injection system 38 to permit maintenance of the fluid injection system 38. Also, as shown in FIG. 8, the substrate base 58 is positioned along the bottom of the reactor 32, and may include one or more holes to accommodate the fluid injection system 38 and gas injection system 46. Furthermore, in this example, an inorganic mesh fabric 88 can be attached to the interior side walls 54 of the reactor 32, e.g., to facilitate lateral drainage pathways down the side walls 54, for example during a dewatering process.

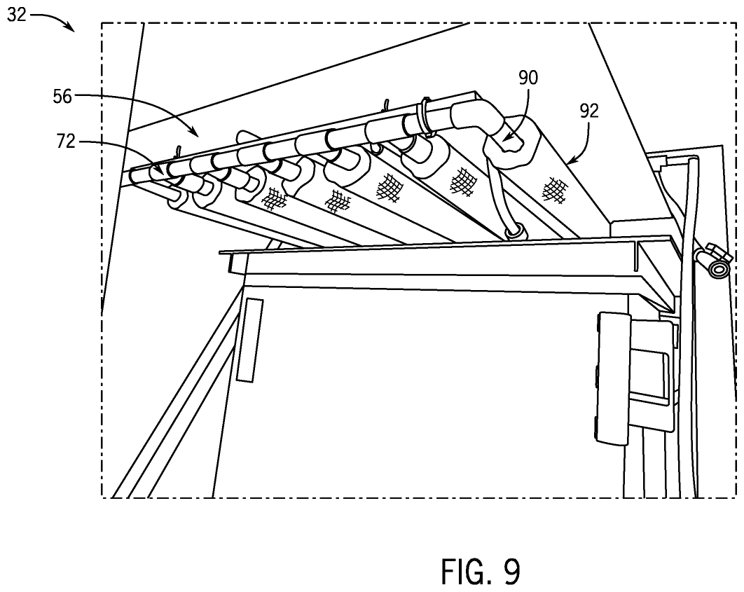

As shown in FIG. 9, the reactor 32 can include a removable roof 56 that covers the opening 86. The roof 56 can be clamped, locked or otherwise fixed over the opening 86 to seal the reactor 32. As shown in FIG. 9, a surface drain 72 can be coupled to the interior-facing surface of the roof 56. In an embodiment, the surface drain 72 can at least include perforated pipes 90 wrapped with a filter material 92. The filter material 92 can prevent solids from entering the perforated pipes 90. The surface drain 72 is fluidly coupled at least to the LFT 14 and allows liquids and/or gasses to exit the reactor 32.

Generally, the ULBR 12, as described herein according to some embodiments, can operate in a multimodal fashion to condition organic waste, such as solid waste feedstocks (e.g., animal manures, agricultural biproducts, municipal solid wastes, etc.), hydrate the wastes, and facilitate the bioprocessing the wastes, before dewatering and deodorizing the resulting digestate. Leachate 24, and gases such as steam and air are delivered to the base of the ULBR 12 to hasten the degradation of the waste.

More specifically, referring back to FIGS. 1-3, the MSAD 10 can operate in a multistage approach to digest high solids waste works by utilizing a separate reactor 32 for solids and separating the anaerobic digestion process into three components: the ULBR 12, LFT 14, and FFR 16. The initial high-solids substrate 20 to be digested can be placed in the reactor 32. The reactor 32 is equipped with the fluid injection system 38 on the bottom of the reactor 32 and the surface drain 72 at the top of the reactor 32. This configuration enables upwards flow of the liquid through the waste. The surface drain 72 can include a phase separation filter 92 to allow the liquid to leave while retaining the solid portion in the ULBR 12. This leachate 24 is deposited into the LFT 14, which acts as a central hub of the system 10. Leachate 24 is drawn out of the LFT 14 and directed to feed into the FFR 16, which houses the methanogens on attached growth media. The organic materials leached from the substrate 20 are readily degraded in the FFR 16 to produce biogas. The digested leachate 24 that is depleted of methanogen nutrients is then recycled by discharging back into the LFT 14. Depleted leachate 24 from the FFR 16 mixes with fresh leachate 24 in the LFT 14 and can be directed back into the ULBR 12 to replenish the BMP.

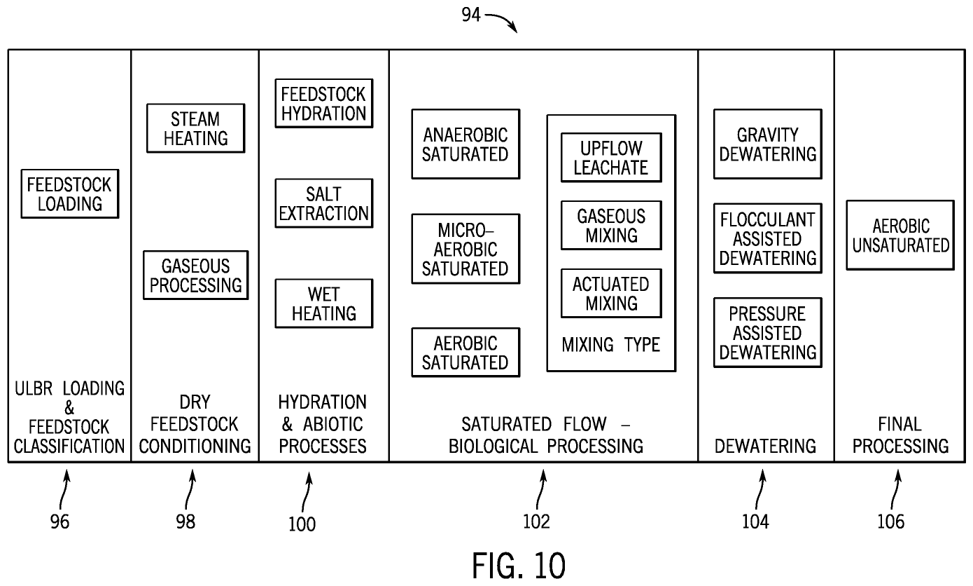

For example, FIG. 10 illustrates a chart 94 showing example operational processes that can be executed through ULBR 12 according to some embodiments. Generally, the chart 94 is illustrated and described below as a linear progression. However, it should be noted that an operational process can include all of the steps described herein, some combination of the steps described herein, or additional steps not specifically described herein, and such steps can be performed in the order shown, though some steps may be repeated before progressing to a subsequent step or certain loops, e.g., from one step back to a previous step can be performed and/or repeated.

More specifically, step 96 includes ULBR loading and feedstock classification. At step 96, solid handling equipment (such as trucks and wheel loaders) can load feedstock into the ULBR 12 through the opening 86 on the top or the side thereof, or pumped in through an alternate opening in the side or bottom (not shown). The feedstocks can be added to a reactor 32 by themselves, or mixed with other feedstocks and/or biological inoculants (include solid or liquid inoculants). Such additions can assist with the digestion process by permitting or facilitating the growth of microbes by providing a diversity of nutrients as well as organisms that are acclimated for these feedstocks.

Additionally, the feedstock can be imaged and/or measured with sensors for classification as it is loaded. Based on feedstock classification, various treatment pathways can be considered to facilitate the optimal digestion of the feedstock. As noted above, feedstock can include varieties of biomass including, but not limited to, animal manures, agricultural biproducts, municipal solid wastes, and seaweed. Furthermore, the feedstock can include solid waste, liquid waste, or a mixture thereof.

Step 98 includes feedstock conditioning. Such conditioning can be performed on dry feedstock or wet feedstock (e.g., feedstock that has previously been hydrated). In some applications, at step 98, steam heating can be performed. Steam can be used to heat the feedstock, for example, to >60° C. while at a high solids content. The elevated temperatures can inactivate pathogens and facilitate the thermal hydrolysis of polymers. This type of conditioning is useful for the treatment of slaughterhouse solids, feedlot mortalities, and recalcitrant solids such as feedlot manure. Additionally, at step 98, gaseous processing can be performed. As described above, gases other than steam, such as, but not limited to, air, ammonia, or ozone can be added to the process via the gas injector system. These gases can facilitate heating, oxidation, and substrate hydrolysis. For example, air injection can provide aerobic processing, e.g., a biological method. In addition, ammonia or ozone injection can provide further oxidation processing, providing an additional and/or alternative approach to facilitate breaking down compounds within the feedstocks.

Step 100 includes hydration and abiotic processes. For example, feedstock hydration can include dilution water 18 or leachate 24 being added to the ULBR 12 via the fluid injection system 38. Once the feedstock is saturated, pore space gasses are displaced. Salt extraction can be performed, where leachate 24 can be added to the substrate 20 in the ULBR 12 and maintained without exchange. In this process, the leachate 24 mixes with the substrate 20 such that all available salt in the substrate 20 dissolves in the leachate 24. After a time, the substrate 20 can be dewatered and the resulting hypersaline solution can be collected separately for methanogenic treatment (e.g., in a separate saline polishing reactor). This hypersaline solution is the reactor effluent and contains the bulk of the liquid effluent from the process. In some embodiments, salt extraction may be repeated within the first 24-48 hours to facilitate the recovery of salts and reduce the water requirements of the process. Additionally, wet heating can be performed at step 100. That is, hydration water can be heated to 40-60° C. and used to preheat the substrate 20. This process inactivates pathogens and facilitates the thermal hydrolysis of polymers in the substrate 20.

Step 102 includes saturated flow biological processing modes, including anaerobic saturated, microaerobic saturated, and aerobic saturated, along with mixing including upflow leachate mixing and gaseous mixing. Regarding anaerobic saturated processing, anaerobic leachate 24 can be pumped into the reactor 32 through the fluid injection system 38. The anaerobic leachate 24 can circulate through the substrate 20 to the upflow leachate outlet (e.g., the leachate collector 48 or the surface drain 72). The substrate 20 in the reactor 32 is mixed by injection of leachate or can be mixed using other methods. For example, injection of biogas can be used to mix the substrate 20. In another example, the flexible bladders can be selectively inflated, as described above, to cause the substrate 20 to mix the substrate 20.

Regarding microaerobic aerobic saturated processing, anaerobic leachate 24 can be pumped into the reactor 32 by the fluid injection system 38 and then circulated to the upflow leachate outlet (e.g., the leachate collector 48). To establish microaerobic conditions, small volumes of air can be added to the substrate 20 by the gas injection system 46 to increase the hydrolysis rates. The addition of oxygen gas can encourage bacterial growth. Air can be added at the beginning of the process, incrementally, or gradually over the duration of the process. The substrate 20 can be mixed with leachate 24 by roiling or agitating the substrate 20 by gas injection of air or other gases. Additionally, and alternatively, the substrate 20 can be thoroughly mixed with leachate 24 by the multi-bladder actuated mixing as described above. Regarding aerobic saturated processing, air can be added to the aerobic process to deodorize the waste. Additionally, and alternatively, aerobic leachate 24 can be added to and mixed with the substrate 20 by leachate mixing or bladder actuated mixing as described above. Furthermore, while anaerobic saturated, microaerobic saturated, and aerobic saturated processing are described and shown in a particular order, it should be noted that, in some applications, these processing steps may be performed in a different order than what is shown.

Step 104 includes ULBR dewatering, which may include gravity dewatering, flocculant assisted dewatering, and/or pressure-assisted dewatering. More specifically, post-digestion dewatering is a process for removing excess liquid from the substrate 20 to make the resultant material easier to manage. Regarding gravity dewatering, in one example, gravity works on the substrate 20 such that solids settle on the substrate base 58 and excess liquid can exit through the sides and base of the reactor 32 to the drain 60. Regarding flocculant assisted dewatering, flocculants or coagulants can be pumped into the substrate 20 using the fluid injection system 38. The substrate 20 can be mixed with the flocculant or coagulant using agitation by gas or liquid. Excess liquid can exit through the sides and base of the reactor 32 to the drain 60. Additionally, regarding pressure assisted dewatering, the pneumatically actuated bladder 82 at the apex of the reactor 32 can be inflated, imparting pressure to the surface of the substrate 20. The substrate 20 is thereby compressed, causing excess liquid to separate from the substrate 20. Excess liquid can exit through the sides and base of the reactor 32 to the drain 60.

Following dewatering, final processing at step 106 can include aerobic unsaturated processing. For example, such processing can include flowing gas through the substrate 20, e.g., via the gas injection system.

It should be noted that all of the processes of steps 96-106 can be performed within the ULBR 12. As such, the ULBR 12 can be a multipurpose vessel that can operate as a self-contained waste processing vessel. For example, dewatering can be performed in the same reactor 32 as other processing steps, which is not generally done in conventional reactor systems. Additionally, because the reactor 32 can be rapidly filled and drained, the reactor 32 can switch between aerobic and anaerobic processes without unloading the substrate 20, allowing anaerobic digestion and aerobic composting to occur in the same vessel. Compared to systems that require removal of organic feedstock after anaerobic digestion, the ability to perform both anaerobic digestion and aerobic composting in the same vessel reduces odor generation, total waste processing time, and reduces waste handling time and equipment requirements. Furthermore, an individual reactor 32 can be taken offline, emptied, and refilled with new substrate 20 once a desired leaching potential is reached. This approach allows for the MSAD 10 to have a modular configuration with multiple reactors 32 running simultaneously and independently, wherein an individual reactor 32 can be taken offline while the remaining reactors 32 continue processing operations. Accordingly, each reactor 32 can be operated as a batch load system, for example, as opposed to the FFR 16 within the MSAD 10, which may incorporate a continuous flow recirculation process.

Additionally, in some embodiments, the ULBR 12 can be operated as a methanogenic producing unit, thus eliminating the need for a dedicated FFR. More specifically, a first reactor 32 can be loaded with organic material and substrate retention time can be increased. Bacteria produce methane in the substrate 20, and leachate 24 can be circulated through the first reactor 32 as it would an FFR. That is, organics in the leachate 24 are degraded in the reactor 32 to produce biogas, and the digested leachate 24 is then discharged back into the LFT 14 where it can be fed back into another reactor 32 to replenish the biochemical methane potential. This design could reduce MSAD system costs long term as it reduces the need for methanogenic reactor capacity, such as a dedicated FFR.

In light of the above, a multistage ULBR 12 according to some embodiments can be an attractive technology for waste handling because it implements effective anaerobic digestion to treat common solid waste feedstock or low-value waste material into energy and other valuable products 22 including compost and fertilizers and methane biogas 30, while performing the necessary treatment for proper waste disposal. This technology can be implemented, for example, in arid regions to digest high solids waste such as dry-lot cattle manure. The system is modular, and by utilizing the features described herein, the digestion process is much more feasible when compared to downflow LBR. This improvement in feasibility is provided as there are multiple ways to mix the digester, extract organics from the digestion, and drain the reactor that are not permitted in other reactors systems. Furthermore, upflow LBR, utilizing one or more of the features described herein, can provide improved leachate flow compared to downflow LBR, and such improved flow can decrease chances of clogging, failures, and related maintenance. Additionally, the modular system and upflow configuration permits leachate recycling from one reactor to another, which can further improve digestion in subsequent reactors. Accordingly, this system presents the opportunity to harness the many noted benefits of anaerobic digestion in a new application that can be used for large-scale operation, making it an attractive waste handling option.

That is, the ULBR 12 is an effective and efficient way to process a variety of solid wastes. The ULBR 12 operates in a multimodal fashion to condition solid feedstocks, hydrate the wastes, and facilitate the bioprocessing the wastes, before dewatering and deodorizing the resulting digestate. Biotic and abiotic processes are facilitated using specially designed fluidic structures that facilitate the passage of gaseous and liquid reactants through the feedstock. Leachate, and gases such as steam and air are delivered to the base of the ULBR 12 to hasten the stabilization of solid waste feedstocks such as animal manures, agricultural biproducts, and municipal solid wastes. Its ability to process heterogeneous feedstocks, low permeability feedstocks, and feedstocks with nondigestible contaminates makes it an ideal choice for anaerobic solid waste processing. Additionally, its ability to be used as part of a multistage reactor system and pool multiple leachates from multiple vessels makes it even more versatile and can be used to create a highly efficient and effective waste processing system.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An upflow leach bed reactor configured to contain a substrate, the reactor comprising:
a container comprising a floor and a sidewall and configured to contain the substrate; and
a fluid injection system positioned adjacent the floor and configured to inject liquid upward into the substrate, the fluid injection system comprising:
a plurality of fluid inlet ports arranged in an array across the floor, the plurality of fluid inlet ports configured to be moved between a first position below the substrate and a second position at least partially within the substrate.

2. The reactor of claim 1, wherein the plurality of fluid inlet ports includes a first grouping a fluid inlet ports and a second grouping of fluid inlet ports, wherein the first grouping and the second grouping can be individually actuated to selectively inject liquid into different areas of the substrate.

3. The reactor of claim 1, further comprising a lift mechanism configured to move the plurality of fluid inlet ports between the first position and the second position.

4. (canceled)

5. The reactor of claim 1, wherein the fluid injection system is further configured to inject gas into the substrate.

6. The reactor of claim 1, further comprising a gas injection system positioned adjacent the floor and configured to inject gas upward into the substrate, the gas injection system comprising a plurality of gas injection ports.

7. The reactor of claim 6, wherein the plurality of gas injection ports are configured to be moved between a first position below the substrate and a second position at least partially within the substrate.

8. The reactor of claim 1, further comprising a vertical drain extending from the top to the floor and positioned between the substrate and the sidewall, the vertical drain configured to permit downward liquid flow and inhibit upward liquid flow therethrough.

9. The reactor of claim 1, further comprising a surface drain positioned adjacent a top of the container above the substrate, wherein the surface drain is configured to move downward adjacent a top surface of the substrate.

10. The reactor of claim 9, further comprising an inflatable bladder configured to move the surface drain downward.

11. (canceled)

12. The reactor of claim 8, wherein the vertical drain includes a plurality of baffles configured to permit downward liquid flow and inhibit upward liquid flow therethrough.

13. The reactor of claim 8, wherein the vertical drain includes a check valve configured to permit downward liquid flow and inhibit upward liquid flow therethrough.

14. (canceled)

15. The reactor of claim 8, wherein the vertical drain is angled such that it extends further outward toward the sidewall adjacent the top of the container and further inward away from the sidewall adjacent the floor.

16. An upflow leach bed reactor configured to contain a substrate, the reactor comprising:
a container comprising a floor and sidewalls and configured to contain the substrate;
a fluid injection system positioned adjacent the floor and configured to inject liquid upward into the substrate; and
an inflatable bladder positioned adjacent the top of the container and configured to press downward against a top surface of the substrate.

17. The reactor of claim 16, wherein the bladder incorporates a surface drain along a bottom surface thereof.

18. (canceled)

19. The reactor of claim 16, wherein the bladder includes a plurality of bladders arranged side by side, wherein the bladders are selectively inflatable at different rates.

20. The reactor of claim 16, wherein the bladder is configured to store gas produced from the substrate.

21. A method comprising:
loading a feedstock into an upflow leach bed reactor;
conditioning the feedstock, the conditioning including injecting one of ozone and ammonia into the feedstock;
performing biological processing on the feedstock; and
dewatering the feedstock.

22. The method of claim 21, wherein the conditioning further includes injecting air into the feedstock.

23. The method of claim 21, further comprising performing hydration processing on the feedstock before performing the biological processing.

24. (canceled)

25. The method of claim 21, wherein performing the biological processing includes injecting leachate into the upflow leach bed reactor, and further comprising draining the leachate after it has passed through the feedstock and redirecting the drained leachate into a subsequent upflow leach bed reactor.
